(19) United States
(12) Patent Application Publication
(10) Pub. No.: US 2005/0173665 A1
(43) Pub. Date: Aug. 11, 2005

(54) Ball valve having annular spring seats

(76) Inventor: Willard E. Kemp, Houston, TX (US)

Correspondence Address: JAMES L. JACKSON;JAMES L. JACKSON, P.C., 10723 Sugar Hill Drive, Houston, TX, 77042, US

(21) Appl. No.: 11/051,705

(22) Filed: Feb. 4, 2005

Related U.S. Application Data
(60) Provisional application No. 60/542,065, filed on Feb. 5, 2004.

(51) Int. Cl. F16K 25/00; F16K 5/00; F16K 5/06

(52) U.S. Cl. 251/180

(57) ABSTRACT

Annular spring-like seat rings of a floating or trunnion type ball valve are positioned within the angulated seat recess and define inner and outer circular edges, an annular face sealing surface and an annular back face sealing surface. The seat rings each establish annular face sealing with the spherical sealing surface of said valve ball and annular sealing with the annular angulated seat recess surface. The inner periphery of each annular spring-like seat ring is defined by an annular radiused edge providing a smoothly contoured annular internal edge surface establishing initial sealing with the valve ball and minimizing the potential for erosion of the spherical sealing surface of the valve ball during opening and closing rotation of the valve ball. The valve mechanism is provided with a valve stem actuator and a spring cover with adjustable stem rotation stop.

### RELATED PROVISIONAL APPLICATION

Applicant hereby claims the benefit of U.S. Provisional Patent Application No. 60/542,065, filed on Feb. 5, 2004 by Willard E. Kemp and entitled “Ball Valve”.

### BACKGROUND OF THE INVENTION

1. Field of the Invention

The present invention relates generally to rotatable plug valves and particularly to ball valves having a generally spherical rotatable plug member, typically referred to as a valve “ball”. The valve ball may be of free floating or trunnion supported type having at least one and preferably a pair of annular seat members having spring-like yieldable characteristics for maintaining seals between the rotatable ball member and the body structure of the valve. More particularly, the present invention concerns spring-like annular seats for ball valves which establish annular sealing contact with the external spherical surface of a rotatable valve ball member.

2. Description of the Prior Art

U.S. Pat. No. 4,066,240 of Eulas R. Atkinson and Willard E. Kemp discloses a rotatable ball or plug valve having self-compensating seats in the form of Belleville-like springs which are supported within the valve body and have sealing engagement with the spherical surface of the valve ball. At zero or low pressure conditions sharp annular internal circular edges of the seat rings establish essentially line sealing contact with the spherical surface of the valve ball. This annular line sealing contact can develop significant forces per unit area to cause significant wear of both the seat members and the spherical surface of the valve ball. The downstream seat is caused to yield responsive to fluid pressure acting on the ball member in its closed position to permit downstream displacement of the ball member. As the ball member is displaced it causes transition of the sealing contact of the downstream seat member with the ball member from annular line contact by the sharp internal circular edge of the downstream seat to a relatively large area of annular sealing contact.

### SUMMARY OF THE INVENTION

It is a principal feature of the present invention to provide a novel rotatable ball valve mechanism having annular spring-like yieldable valve seats each having narrow, but smoothly contoured annular sealing engagement of the inner periphery thereof with the external spherical sealing surface of a rotatable valve ball member;

It is another feature of the present invention to provide a novel rotatable ball valve mechanism having annular spring-like yieldable valve seats that are placed in a condition of spring preload during assembly of the valve mechanism;

It is also a feature of the present invention to provide a novel rotatable ball valve mechanism having annular spring-like yieldable valve seats that are of different internal diameter to minimize the erosive effects of the valve seats on the external spherical sealing surface of the valve ball member as the valve ball is rotated during opening and closing movement;

It is another feature of the present invention to provide a novel rotatable ball valve mechanism having a top-works and actuating handle arrangement having a unique valve stem drive attachment providing rotary driving force to the valve stem and valve ball members and being adjustable for accurately positioning the valve ball at its open and closed positions;

It is an even further feature of the present invention to provide a novel rotatable ball valve mechanism having adjustable Belleville spring stacks for controllably energizing a stem packing and bearing assembly and having a spring cover member protecting the Belleville spring stacks and the stem packing and bearing assembly from damage by environmental contaminants; and

It is another feature of the present invention to provide a novel rotatable ball valve mechanism having a spring cover member having opposed pairs of inserts, each pair having a torque resisting insert and a rotatable insert each pair being secured to the spring cover by cap screws and with at two of the inserts and cap screws serving as a rotational stops for precision location of the valve ball member at its open and closed positions.

Briefly, the various objects and features of the present invention are realized through the provision of a rotary plug valve mechanism having a valve body defining inlet and outlet flow passages intersecting a valve chamber and having internal annular seat recesses each facing the valve chamber. Annular Belleville type spring seat members are positioned within the internal annular seat recesses and establish annular sealing engagement with the spherical sealing surface of a valve ball member, which may be of the free floating type or may be supported for rotation by trunnions. The spring seat members may be of different internal diameter so that they establish sealing engagement with different annular portions of the valve ball member to minimize erosive wear of the seats and valve ball during valve service. The circular inner peripheries of the spring seat members are radiused to form circular sealing surfaces of smoothly contoured cross-sectional configuration to thus provide narrow, but smoothly contoured circular sealing surfaces to further minimize the potential for erosion of the spherical sealing surface of the valve ball member especially when the valve is subjected to opening and closing movement during conditions of high differential pressure.

A valve stem extends into the valve body and establishes non-rotatable driving relation with the valve ball member and is sealed and supported for rotation relative to the valve body by a bearing and stem seal assembly. The top-works of the valve mechanism is provided with a stem driver having non-rotatable relation with the valve stem and providing an actuator platform having a geometry that is designed to provide opposed shoulders for valve ball positioning. A spring cover member is positioned to cover and provide protection for adjustable Belleville type stem packing springs and the bearing and stem seal assembly and bearing assembly. The spring cover is provided with pairs of opposed recesses each pair receiving a non-rotatable insert and a rotatable insert, the pair being secured in assembly by cap screws. When assembled, two of the pairs of inserts are positioned with the rotatable inserts thereof located above the upper surface of the spring cover and functioning as rotation stop members for stopping contact by the stem driver to thus stop rotation of the valve ball at the open and closed positions. Two pairs of the inserts are positioned so that neither the inserts nor the cap screws project beyond the upper surface of the spring cover, this permitting the actuator platform to pass over them during valve operation to the open and closed positions.

To the stem driver is mounted a pair of spaced upwardly projecting stud members having threaded sections extending through spaced openings of an elongate valve actuator handle member. The handle member is of sufficient length that operating personnel can easily operate the valve mechanism even when the valve is subjected to high pressure conditions. The ends of the elongate handle member are provided with plastic covers or are dipped in plastic material to provide protective end covers for ensuring against potential injury of workers.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an isometric illustration showing a rotary plug valve that is constructed according to the principles of the present invention and represents a preferred embodiment of the invention;

FIG. 2 is a longitudinal sectional view taken through the rotary plug valve of FIG. 1 and illustrating a free floating ball valve type construction;

FIG. 3 is a fragmentary sectional view showing the actuating stem, stem seal, ball and seat arrangement of the embodiment of FIGS. 1-2;

FIGS. 3a-3c are fragmentary sectional views illustrating sequential assembly of the valve mechanism which accomplishes yielding and spring force loading of the annular seat members for sealing with the body and tailpiece and for efficient sealing with the spherical sealing surface of the valve ball member;

FIG. 3d is a partial isometric illustration showing the back face of one of the annular spring-like seat members and showing a radially outer annular sealing portion and a radially outer annular non-sealing portion of the back sealing face;

FIG. 3e is an isometric illustration of the spring cover and stem driver structures and showing the stem driver member in stopped engagement with opposed adjustable rotation stop members projecting from the spring cover member;

FIG. 4 is a sectional view taken through the spring cover member and its cap screws and illustrating the rotatable insert and torque insert thereof in detail;

FIG. 5 is an isometric illustration showing a rotary plug valve being constructed according to the principles of the present invention and representing an alternative embodiment of the invention;

FIG. 6 is a longitudinal sectional view taken through the rotary plug valve of FIG. 5 and showing a rotary spherical plug member or ball having trunnion support within the valve body;

FIG. 7 is a fragmentary sectional view showing the actuating stem, stem seal, ball and seat arrangement of the trunnion ball valve embodiment of FIGS. 5-6; and

FIG. 8 is a partial sectional view of the trunnion ball valve embodiment of FIGS. 5-6 and showing the spring cover member, cap screws, rotatable inserts and torque resisting inserts thereof in detail;

FIG. 9 is a sectional view of a trunnion type ball valve constructed according to the principles of the present invention and having a lubrication system for lubricant enhanced sealing of the seat members with respect to the spherical sealing surface of the valve ball;

FIG. 10 is a partial sectional view showing the details of one the seat carrier members shown in FIG. 9;

FIG. 10a is a fragmentary sectional view of the seat carrier member of FIG. 10, showing the back seal, seal groove and seal support member in detail;

FIG. 11 is an elevational view of one of the annular spring-like seat members that are shown in FIG. 9;

FIG. 12 is an isometric illustration of the annular spring-like seat member of FIGS. 9 and 12 and showing a radially outer annular polished sealing surface and a radially inner annular surface of non-sealing character;

FIG. 13 is a greatly enlarged partial sectional view of the inner annular non-sealing surface of FIG. 12;

FIG. 14 is a sectional view showing a ball valve mechanism representing an alternative embodiment of the present invention and further showing annular seat carrier elements and details of a seat lubrication system thereof; and

FIG. 15 is a sectional view showing an annular seat carrier member having lubricant passages therein for conducting injected lubricant to an annular inclined seat recess for lubrication at the region of sealing contact of the seat members with the spherical sealing surface of the valve ball member.

### DEFINITIONS

The terms “yieldable” or “yielding” as employed are deemed indicative of the capability of the annular seat members of the present invention to become flexed without exceeding the elastic limit of the material from which the annular seat members are composed. The term “spring-like” as used herein is intended to encompass the spring characteristics of metal, polymer, metal/polymer composites, and sintered material having characteristics of lubricity.

### DETAILED DESCRIPTION OF PREFERRED EMBODIMENT

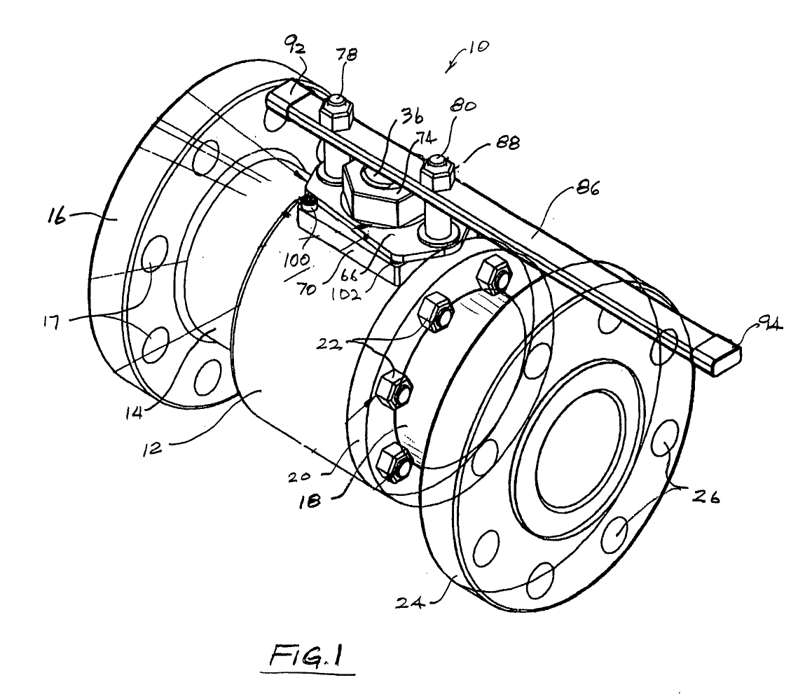

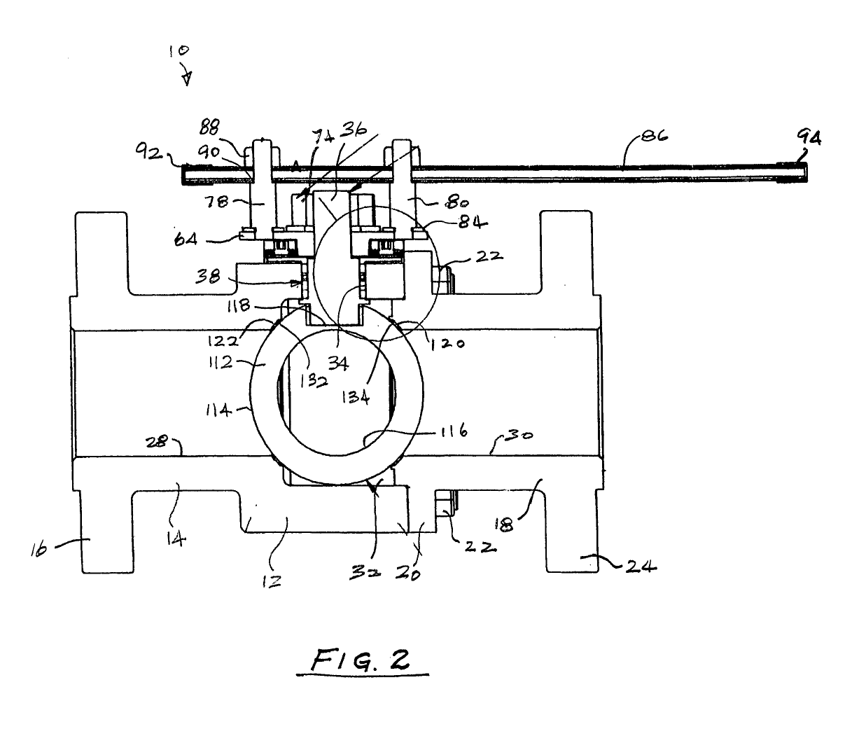

Referring now to the drawings and first to FIGS. 1 and 2, a floating ball valve embodiment of the present invention is shown generally at 10 and comprises a valve body 12 having an integral tailpiece 14 incorporating a mounting flange 16 having bolt openings 17 receiving bolts or studs by which the ball valve is mounted between the spaced mounting flanges of a flow-line, not shown. Though the valve body and tailpiece are shown to be of integral construction, such is not intended to limit the spirit and scope of the present invention. The valve body 12 and tailpiece 14 may be separate elements, such as is shown in FIG. 5 and may be retained in sealed assembly by means of a plurality of retainer studs and bolts or by any other suitable means of connection. A separate tailpiece 18 including an assembly flange 20 is sealed to the valve body 12 by an annular crush ring seal 21 and is secured in fixed assembly with the valve body 12 by means of a plurality of retainer stud and nut assemblies 22. The tailpiece 18 is provided with a mounting flange 24 which, like mounting flange 16, defines a circular array of openings 26 that receive nut and bolt assemblies for securing the valve mechanism between the mounting flanges of a flow-line.

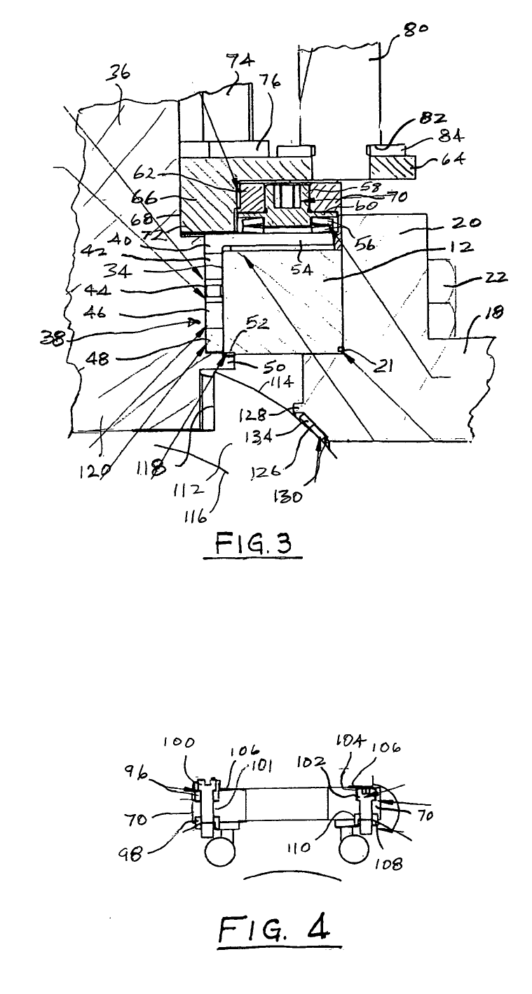

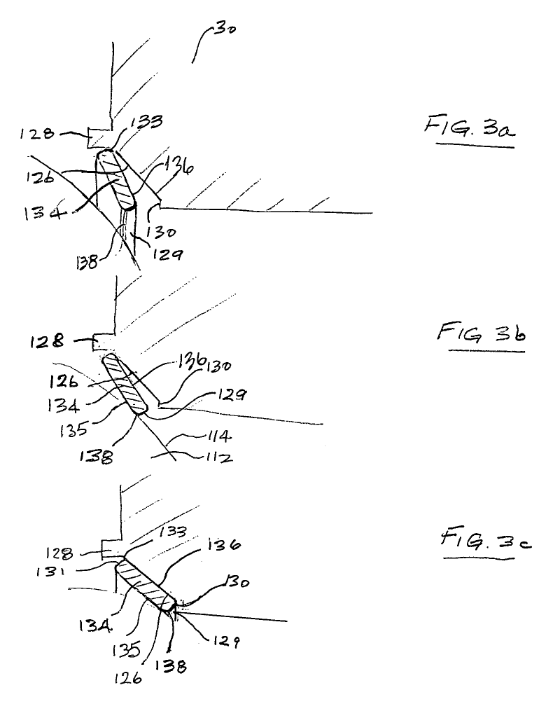

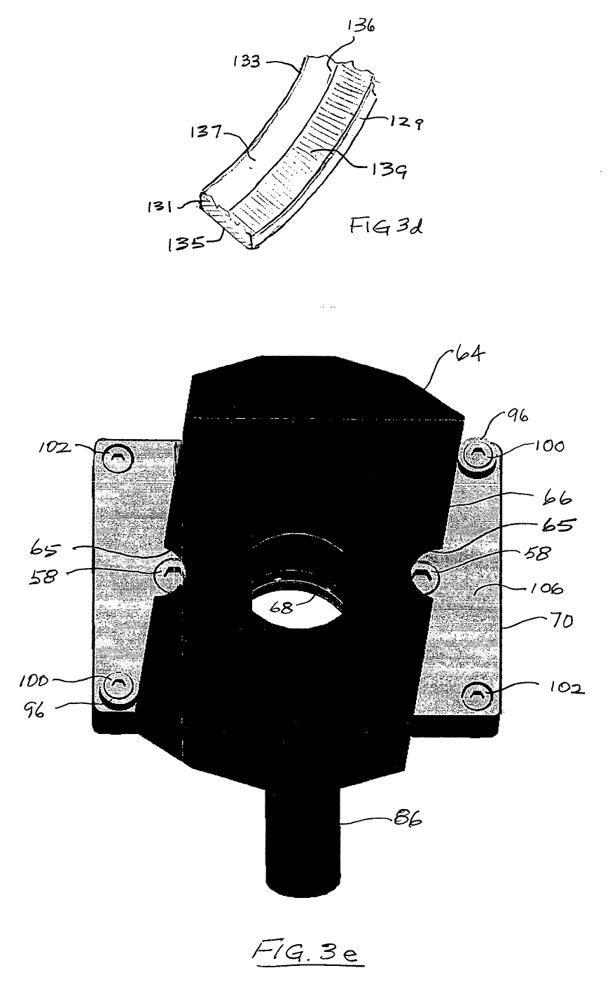

The tailpieces 14 and 18 are of tubular geometry and define inlet and outlet flow passages 28 and 30 that are preferably in aligned registry for straight through flow of the fluid being controlled by the valve. The straight though inlet and outlet flow passages also permit objects such as pigs, scrapers and the like to be passed through the valve mechanism along with flowing fluid, for the purpose of cleaning the flow-line and valve mechanism of internal deposits and debris. The inlet and outlet flow passages 28 and 30 each intersect a valve chamber 32 that is defined collectively by the valve body and the tailpieces. The valve body 12 defines a stem and packing opening 34 within which a rotatable valve stem 36 is mounted and sealed by a bearing and seal assembly shown generally at 38. As is evident from the fragmentary sectional view of FIG. 3, the bearing and stem seal assembly 38 incorporates an upper follower 40, an upper packing ring 42, an intermediate lantern ring 44, a lower packing ring 46 and a lower follower 48, each having a central opening within which a portion of the rotary valve stem is located. The valve stem 36 defines an annular support flange 50 which provides support for the lower follower 48 and also provides support for an annular bearing 52 to ensure against the development of excessive frictional contact of the annular support flange 50 with the annular valve body 12 which might prevent or resist rotation of the valve stem 36 for opening and closing rotation of the ball valve mechanism.

The upper follower member 40 defines an annular support platform 54 on which is seated an opposed pair of spring assemblies each having a plurality of annular Belleville spring elements 56. A spring adjustment screw 58 is provided with a spring compression flange 60 which bears against the uppermost one of the Belleville spring elements 56. The spring adjustment screws are threaded into the annular valve body 12 and achieve adjustment of the force of the spring assembly by means of an Allen or Torx screw driver. Thus the spring adjustment screws control the degree of spring force that is applied through the upper follower member 40 to the bearing and stem seal assembly 38. The spring compression flange 60 also provides for support of a split bearing 62 that is engaged and retained by an actuator plate or platform 64 of a stem driver member 66. The actuator platform defines opposed cut-outs or recesses 65 which permit adjustment access to the spring adjustment screws 58 as shown best in the isometric illustration of FIG. 3e. The stem driver member 66 defines a non-circular opening 68 centrally thereof which is received in non-rotatable relation with an external non-circular portion of the valve stem 36. A spring cover member 70 is retained in contact with the annular valve body 12 and functions to isolate the Belleville springs, adjustment screws and split bearing and from contamination by environmental debris. The spring cover member 70 may also permit a quantity of lubricant to be retained therein for protection and lubrication of the spring assembly and split bearing.

A portion of the stem driver member 66 is positioned above an annular stem retainer shoulder 72 of the valve stem 36 and thus provides for retention of the valve stem against the influence of pressure induced force on the valve stem by the pressure of the fluid being controlled by the valve. A large diameter half-height nut 74, 1-¾ inch diameter for example, depending on the size of the upper threaded portion of the valve stem, is threaded to an upper externally threaded section of the valve stem 36 and secures a large diameter washer 76 in supporting engagement with the nut driver member 66 as shown in FIG. 3.

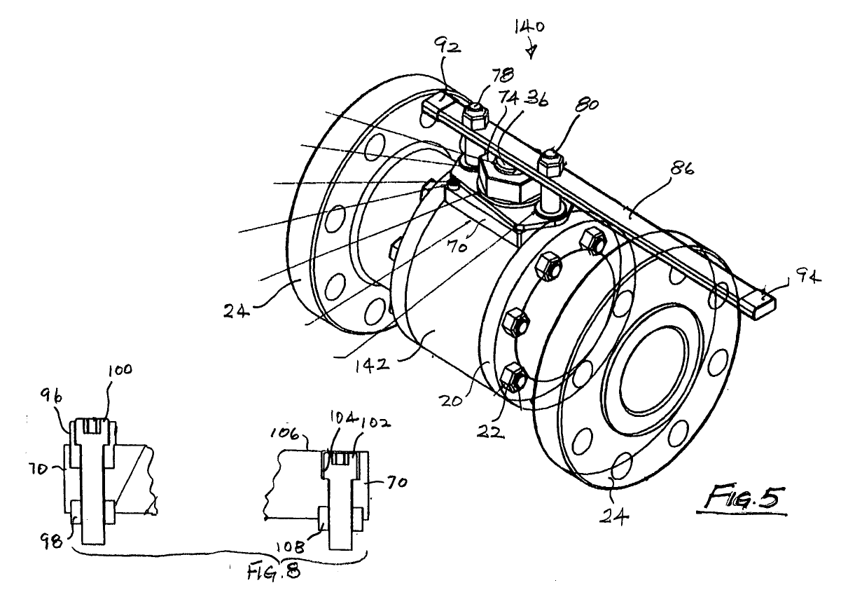

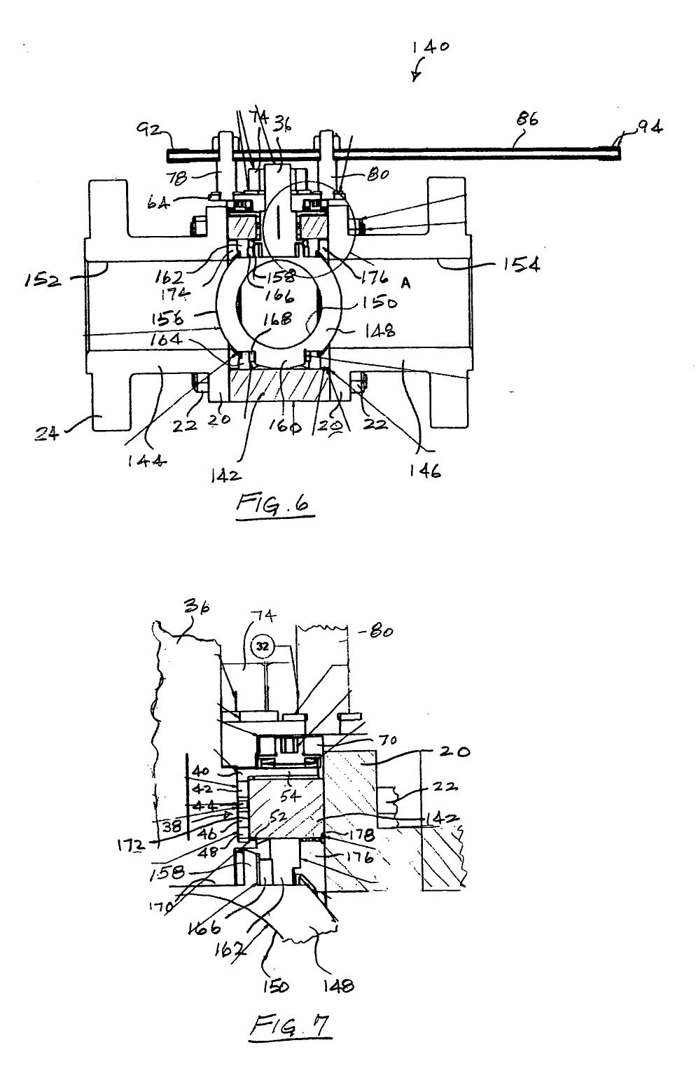

A pair of special stud members 78 and 80 are threaded into openings of the actuator platform or plate 64 of the stem driver 66. As shown in detail in FIG. 4, downwardly facing shoulders 82 of the special stud members engage and establish locking relation with washer members 84. A valve actuating handle 86 defines a pair of spaced openings that each receive upper threaded sections of the special stud members. It should be borne in mind that the top-works or valve actuating mechanism, including the valve stem, valve driver and handle structure are, for purposes of clarity, shown in FIG. 2, and 6 as being oriented substantially 90° offset from the actual positions thereof. For example, in FIGS. 2 and 6 the handle 86 is shown in its open position; however the valve ball is shown in its closed position. Hexagonal lock nuts 88 are threaded to upper threaded sections of the special stud members and force the valve actuating handle 86 into seated relation with annular shoulders 90 of the studs 78 and 80. The elongate valve actuating handle is preferably provided with plastic cover members 92 and 94 at respective ends there to provide protection for workers who grasp the actuator handle and apply sufficient force for rotation of the valve stem 36 or who may be working in the vicinity of the valve. The plastic cover members 92 and 94 may be simply installed in covering relation with the respective ends of the actuating handle or, in the alternative, the ends of the handle member may be dipped in molten plastic which cools and solidifies to provide protective end covers for the actuating handle. As a further alternative, the ends of the actuator handle may be left bare and may be slightly rounded or contoured to ensure protection against damage to the hands of workers.

With reference to the isometric illustration of FIG. 3e and the sectional view of FIG. 4, which is a sectional view through the spring cover member 70, the relation of the spring cover member, the rotation control inserts and the cap screws is illustrated in detail. The cap screws extend through the spring cover and are threaded into screw openings of the valve body. Opposed pairs of insert recesses and cap screw openings are formed in the spring cover member 70 and receive the threaded shank portions of the cap screws. A rotation control insert 96 and a non-rotatable torque insert 98 are seated within respective opposed insert recesses.

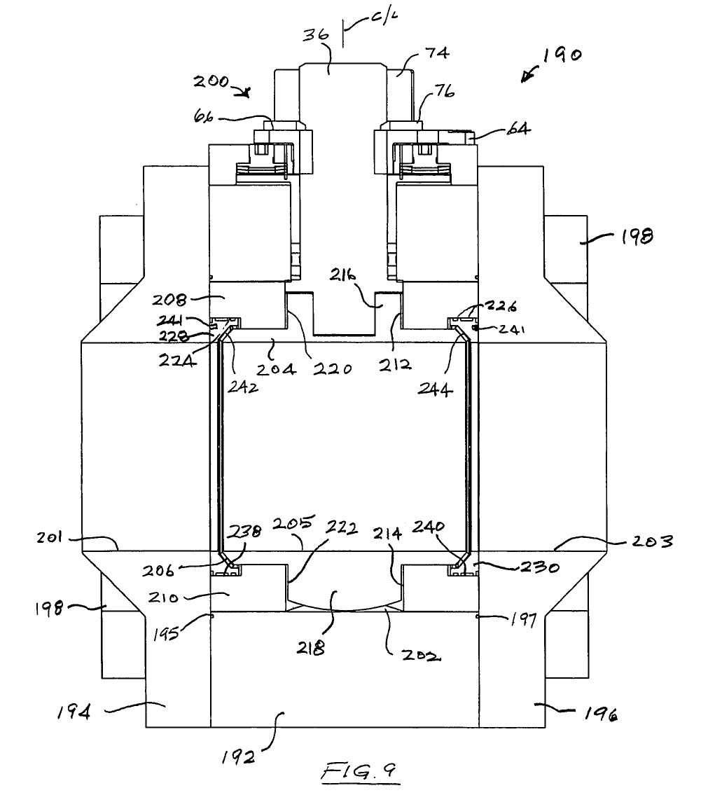

The rotation control inserts 96 serve as stop members for engagement by the actuator platform 64 of the stem driver member 66 as shown in FIGS. 3e and 4 and as also shown in FIG. 8. The recesses for the rotatable control inserts 96 are preferably of generally cylindrical internal configuration and the rotatable inserts 96 are of generally cylindrical external configuration, with the outer cylindrical surfaces thereof being located eccentrically of a cap screw opening or passage that extends through each of the inserts. When the rotation control inserts 96 are rotated on their cap screws, the outer cylindrical surfaces of the inserts move eccentrically with respect to the cap screws, thereby causing adjustment of the stop position for the stem driver 66. The rotatable stop adjustment inserts 96 may have an enlarged receptacle to receive at least a portion of the head of a cap screw. Allen or Torx type cap screws 100 extend through the rotatable insert 96 and cap screw openings of the spring cover extend through the torque insert 98. A portion of the insert 96 and the head of the cap screw 100 project above the upper generally planar surface 106 of the spring cover 70 and function as a rotation stop member which is engaged by the actuator platform 64 to limit rotational movement of the actuator platform and thus the stem driver 66 and valve stem 36 when a desired stop position is achieved.

Adjustment of the stop position of the stem driver is achieved by loosening the cap screw and rotating the stop adjustment insert to a desired eccentric position and then tightening the cap screw to secure the stop adjustment insert at the desired position. The rotation stop is positioned with respect to the stem driver so that the flow port of the valve ball member is precisely aligned with the inlet and outlet flow passages when the actuator platform comes into stopped engagement with the rotation stop member. The opposed torque insert recesses and the torque inserts 98 are each of corresponding non-circular cross-sectional configuration so that the torque insert is non-rotatable with respect to the spring cover member. Thus as the threaded shank of the cap screw 100 is threaded into the torque insert, the torque insert is restrained from rotation even though significant torque force may be applied to the cap screw for positively positioning and securing the insert 96 to function as a rotation stop member. As shown at the right hand portions of FIGS. 4 and 8 a pair of cap screws 102 are received within cap screw recesses 104 such that the head portion of the cap screws 102 do not project above the upper generally planar surface of the spring housing 70. This feature permits the actuator platform 64 to pass freely over these cap screws 102 during opening and closing movement of the stem driver 66. The non-rotatable inserts 108 are received within non-circular recesses of the spring housing 70 thus permitting the cap screws to be threaded into cap screw openings of the valve body.

It should be noted that cap screw 100 is of greater length as compared with cap screw 102. The head of the cap screw 102 is completely received within a cap screw recess 104 of the spring cover member 70 so that the head of the cap screw does not project above the level of a top planar surface 106 of the spring cover member. As mentioned above, the recessed positions of the cap screws 102 and the adjustable rotatable inserts ensure that the configuration of the actuator platform can be accommodated and the stem driver can be rotated 90° to achieve the open and closed positions of the valve ball. In comparison, as explained above, the head of the cap screw 100 projects above the top planar surface 106 so that the head of the cap screw functions as a stop member to limit rotation of the stem driver. The threaded shank of each cap screw 102 extends through an opening of the spring cover member 70 and is received by a similar non-rotatable torque insert 108 that is seated within an insert recess or receptacle 110. The terminal ends of the threaded shanks of the cap screws are received within respective threaded openings of the valve body.

A rotatable valve ball member 112 is positioned for rotation within the valve chamber 32 and defines an outer, generally spherical sealing surface 114 which is surface hardened and polished to promote metal-to-metal sealing and to minimize seat erosion as the valve ball member is rotated between its open and closed positions. The rotatable valve ball member 112 also defines a through port 116 which is preferably of substantially the same internal diameter as the diameter of the inlet and outlet flow passages 28 and 30. This feature minimizes the turbulence of the fluid flowing through the valve and permits maximum flow while minimizing the pressure drop across the valve mechanism. This straight through flow passage arrangement also permits the passage of pigs or scrapers through the valve as may be necessary for maintenance of the flow-line in which the valve mechanism is mounted. The rotatable valve ball member 112 defines a stem slot 118 within which a lower, non-circular portion 120 of the valve stem 36 is received in non-rotatable relation. Thus, as the valve stem 36 is rotated the valve stem imparts rotary motion to the rotary ball member to move it between its closed position shown in FIG. 2 to an open position where the flow port 116 is in fluid flow permitting registry with the flow passages 28 and 30.

It should be borne in mind that the present invention is applicable to floating ball valves, where the valve ball is capable of being moved in the downstream direction, especially when the valve ball member is in its closed position to thus apply pressure induced force of the valve ball on the downstream seat of the valve mechanism. The present invention is also applicable to trunnion ball valves where the valve ball is mounted by trunnion member for rotation by a valve stem member. In this case, due to manufacturing tolerances, the valve ball will have slight pressure responsive movement in the downstream direction when closed to a flow-line that is under pressure.

As is evident from the longitudinal sectional view of FIG. 2 and from the detailed fragmentary sectional view of FIG. 3, the valve body 12 defines an annular angulated seat recess 122 which is located at the juncture of the flow passage 28 with the valve chamber 32. A second annular angulated seat recess 124 is defined by the separate tailpiece 18, which is located at the juncture of the flow passage 30 with the valve chamber 32. As shown in detail in FIG. 3, the annular angulated seat recesses 122 and 124 are each defined by an annular angulated, i.e., frusto-conical surfaces 126 and by an annular seat retainer rim 128 that is integral with the tailpiece structure 18 and projects axially toward the spherical sealing surface 114 of the rotatable valve ball member 112. The angulated seat recess 122 is also defined in part by an annular retainer shoulder 130.

Annular spring-like seat members 132 and 134 are positioned within the seat recesses 120 and 122. Each of the annular spring-like seat members is generally in the form of Belleville spring and, if composed of metal, is typically composed of spring-steel or its equivalent. If desired, however, the annular spring-like seat members may be composed of any non-metallic material that is suitable for the service conditions for which the valve is intended. For example, the seat members may be composed of one of a number of polymer materials or a ceramic material or any suitable composite of metal and non-metal materials.

The annular spring-like seat members 132 and 134 each have opposed annular sealing edge surfaces, an angulated or frusto-conical face sealing surface 135 and an annular angulated or frusto-conical back face sealing surface 136. The annular spring-like seat members are each typically surface hardened to a hardness of at least 60 Rockwell C. At least a radially inner peripheral portion of the face sealing surface 135 is polished to a fine finish and located for sealing engagement with the spherical sealing surface 114 of the valve ball member 112 and to minimize ball and seat erosion during opening and closing rotation of the valve ball member 112 during fluid controlling service. At least the radially outer portion of the back face sealing surface 136 is polished to a fine surface finish to achieve efficient sealing with the angulated seat recess surface 126.

Though the entire back face sealing surface of the annular spring-like seat members may establish sealing engagement with the annular angulated seat recess surface 126, it is considered more desirable to limit such sealing engagement to a radially outer portion of the annular back face surface 136. Thus, the back face sealing surface 136 may be highly polished at a radially outer annular portion 137 thereof for efficient sealing with the angulated seat recess surface 126 and a radially inner annular portion 139 thereof may be of roughened or otherwise non-sealing character. This feature ensures that only the radially outer portion of the annular back face sealing surface 136 will become sealed to the angulated seat recess surface 126 when the annular spring-like seat member has been yielded to its full extent. This feature also ensures the presence of a narrow annular band of sealing contact at virtually all pressure conditions to which the valve is designed. Also, it should be borne in mind that the annular spring-like seat members, even when yielded or flexed to their maximum extent, will not be yielded or flexed beyond their elastic limit and will consistently return to their unstressed condition.

Especially when valve ball erosion can be significant due to the intended service conditions, the annular spring-like seat members 132 and 134 may have different internal diameters so as to establish different annular areas of sealing contact of the annular seat members with the hardened and polished spherical sealing surface 114 of the valve ball. By contacting the valve ball member 112 at different annular areas, erosion of the spherical sealing surface may be minimized. It is also within the spirit and scope of the present invention to provide annular spring-like seat members that are composed of materials, such as sintered metals, or metal/polymer composite materials, which permit the spring-like seat members to “run dry”. These materials provide a lubrication-like quality that ensures against unusual wear or erosion of the seat members or the spherical sealing surface of the valve ball when the valve is operated under conditions where a fluid is not present in the flow-line being controlled by the valve.

The annular back sealing surface 135 of each annular spring-like seat member, being surface hardened and polished to a fine finish as indicated above, establishes efficient metal-to-metal seating contact with the annular angulated seat recess surface 126. The annular back face sealing surface is preferably of substantially frusto-conical configuration, but may also be of convex or concave cross-sectional configuration if desired depending on the geometry of the angulated seat recess surface. Likewise, the annular angulated seat recess surface 126 is preferably of frusto-conical configuration, but may be of convex or concave cross-sectional configuration depending on the cross-sectional configuration of the annular spring-like metallic seat members.

The annular spring-like seat members 132 and 134 each define an internal peripheral edge 129 and an external peripheral edge 131. The intersection of the annular face sealing surface 135 with the radially inner annular edge 129 is radiused as shown at 138 in FIGS. 3a-3c to provide a smoothly contoured circular edge for sealing engagement with the spherical sealing surface of the valve ball member. This feature ensures that the spherical sealing surface 114 of the ball member 112 is not contacted by a sharp circular edge either during assembly of the valve mechanism or during operation of the valve at all pressure conditions. The smoothly contoured internal radiused edge 138 establishes sealing engagement with the valve ball upon assembly. When the valve ball member is in its closed position and under line pressure, the pressure acting on the valve ball member can develop a force on the valve ball that yields the downstream seat member to its maximum extent, thus positioning the back face sealing surface 136 of the downstream seat member in face-to-face supported sealing contact with the angulated seat recess surface 126. The seat member under this stressed condition, however, will not be stressed beyond its elastic limit and will returned to its originally installed condition by its spring characteristic upon release of the pressure responsive force acting on the valve ball. At stressed conditions the downstream seat member will yield, causing an increased radially inner peripheral portion of the annular face sealing surface to establish sealing engagement with the spherical sealing surface of the valve ball member. Simultaneously, pressure responsive movement of the valve ball member will cause an increased radially outer peripheral portion of the annular back face sealing surface 136 to establish sealing with the angulated seat recess surface 126.

The radially outer periphery of each of the annular spring-like seat members is defined by a generally circular edge 131 which is radiused at its juncture with the annular back face surface thus defining a generally circular smoothly contoured edge 133 that establishes a narrow band of sealing engagement with the radially outer extent of the annular angulated seat recess surface 126. As the seat is yielded by pressure responsive force of the valve ball from the position of FIG. 3a toward the maximum yielded position of FIG. 3c the narrow band of sealing contact of the back face surface 135 with the seat recess surface will increase to a more face-to-face sealing condition.

As shown in FIGS. 3a-3c, which represent different seat, ball and body conditions during assembly of the valve mechanism, initially the outer diameter of the seat 134, defined by the radiused or smoothly contoured annular edge 133, is in spaced or non-sealing relation with the radially outer extent of the angulated seat recess surface 126. In this condition the annular seat members are positioned and centralized by the annular seat positioning rim 128 with respect to the flow port of the valve ball member 112 and the flow passages 28 and 30 of the body 14 and tailpiece 18. The outer spherical sealing surface 114 of the ball member 112 also has a centralizing influence on the seat members during assembly of the valve mechanism.

As the stud and nut assemblies 22 are tightened the annular angulated seat recess surfaces 126 of the body and tailpiece will each be drawn toward the spherical sealing surface 114 of the valve ball until the radiused, smoothly contoured annular inner peripheral edges 138 of each of the spring-like seat members come into contact with the spherical sealing surface of the valve ball as shown in FIG. 3b. At this point the radiused or smoothly contoured inner peripheral edges 138 of each of the spring-like seat members establish a narrow band of sealing engagement with the spherical sealing surface 114 of the valve ball. Also the radiused or smoothly contoured outer peripheral edges 133 of each of the spring-like seat members will establish sealing engagement with the radially outer extent of the angulated sealing surface 126. Also at this point the annular spring-like seat members 132 and 134 will have been somewhat yielded and spring loaded so that the narrow bands of sealing engagement with the valve ball will be maintained even in the absence of fluid pressure.

When the valve has been pressurized to a mid-range pressure condition and is in its closed condition, the downstream annular spring-like seat member 134 will have been yielded or flexed to the configuration shown in FIG. 3c. In this condition of the downstream annular spring-like seat member a significant radially inner annular region of the annular face sealing surface 135 will be in sealing engagement with the spherical sealing surface 114 of the valve ball member 112. Also at this point a significant annular region of the annular back face sealing surface 136 of the seat members will be in sealing engagement with the annular angulated seat recess surface 126 of the respective seat recess. In the event the closed valve is subjected to fluid pressure near its designed maximum rated pressure, the downstream spring-like seat member will be efficiently supported by the angulated angulated seat recess surface 126 so that it cannot be stressed beyond its elastic limit. Obviously, if the line pressure on the valve mechanism is reversed, then the upstream seat will become the downstream seat and vice versa. Consequently this valve mechanism may be employed in bi-directional flow-lines.

When the face sealing surface of the seat members is polished and the back face surface 136 defines a highly polished inner peripheral region 137 and a roughened or non-sealing inner peripheral portion 139 to restrict sealing to a radially outer region of the annular spring-like seat. Even at higher pressure conditions of valve service the annular spring-like seat members will maintain a narrow band of sealing engagement with the valve ball, i.e., a band of sealing engagement that is of less dimension as compared with the entire annular dimension of the back face sealing surface. When this condition occurs, the angulated seat recess surface prevents the seat from being stressed beyond its elastic limit. Thus, when the pressure responsive force is depleted, the downstream spring-like seat member will return to its normal condition.

Referring now to FIGS. 5-9, a trunnion type ball valve is shown generally at 140 which is constructed in accordance with the principles of the present invention. The ball valve 140 incorporates many of the unique features of the floating ball valve 10, thus like components are identified by like reference numerals. The ball valve 140 incorporates a central annular body section 142 to which separate tailpieces 144 and 146 are mounted by stud and nut assemblies 22 that extend through openings of assembly flanges 20 of the respective tailpieces. The tailpieces 144 and 146 are also provided with mounting flanges 24 by which the valve mechanism is mounted into a flow-line having corresponding valve mounting flanges. The central body section 132 and the tailpieces 144 and 146 cooperate to define a valve chamber within which a valve ball member 148 is located. The valve ball member defines a flow port 150 having a diameter essentially conforming to the diameter of inlet and outlet flow passages 152 and 154 of the tailpieces 144 and 146. The valve ball member 148 also defines an external generally spherical sealing surface 156 which is surface hardened and polished for efficiency of sealing. The valve ball member 148, to ensure that it is rotatatable but not substantially moveable downstream by line pressure, further defines upper and lower trunnion members 158 and 160. The trunnion members are supported by upper and lower trunnion support members 162 and 164 that are each defined by trunnion segments that are contained and supported within the valve body. Upper and lower bearing members 166 and 168 are interposed between the trunnion members and the trunnion supports to provide for efficient rotation of the valve ball member about its upper and lower trunnion members during opening and closing rotation of the valve ball member 148.

Referring particularly to FIG. 7, the topworks, i.e., valve actuating mechanism and packing energization system are essentially of the design and function as discussed above in connection with FIGS. 1-4. The upper trunnion member 158 defines a non-circular stem recess 170 within which is seated the lower, non-circular end section of a valve stem 36, thus establishing a non-rotatable relation between the valve stem and the valve ball member 148. The valve stem 36 extends through a stem passage 172 of the central body section 142 and is sealed and supported for rotation relative to the central body section by a bearing and stem seal assembly 38. The bearing and stem seal assembly includes spaced packing rings 42 and 46 and a lantern ring 44 that is interposed between the packing rings. Upper and lower packing follower members 40 and 48 engage the respective packing rings 42 and 46 and permit the application of force to the packing rings to enhance the sealing capability thereof. An annular bearing 52 is mounted about the valve stem and engages the valve body about the stem passage to minimize friction and promote ease of stem rotation and minimize the required force for opening and closing rotation of the valve ball.

Annular seat carriers 174 and 176 are each secured in assembly with the central body section by the respective assembly flange ends 20 of the tailpieces 144 and 146 and are each sealed to the central body section and tailpieces by annular resilient seal members 178. The annular seat carriers 174 each define annular angulated seat recesses shown generally at 180 which are of essentially the same configuration and for the same purpose as discussed above in connection with annular angulated seat recesses 122 and 124 essentially as shown in FIGS. 2 and 3. The annular seat carriers each define annular seat retainer rims 128 that project axially therefrom and serve to minimize any friction responsive lateral movement of annular spring-like seat members 132 and 134 within the seat recesses as valve ball member 148 is rotated during opening and closing movement. The annular spring-like seat members 132 and 134 are each of the construction, design and function as discussed above in connection with FIGS. 2, 3 and 3a-3c. Also, as mentioned above, the annular spring-like metal seat members preferably have different internal diameters and define radiused or smoothly contoured inner peripheral edges so that they establish narrow bands of annular sealing engagement with different annular regions of the spherical surface of the valve ball member and minimize the potential for causing wear or erosion of the spherical sealing surface. The annular spring-like seat members are also of essentially the same configuration and purpose as discussed above in connection with FIGS. 2 and 3.

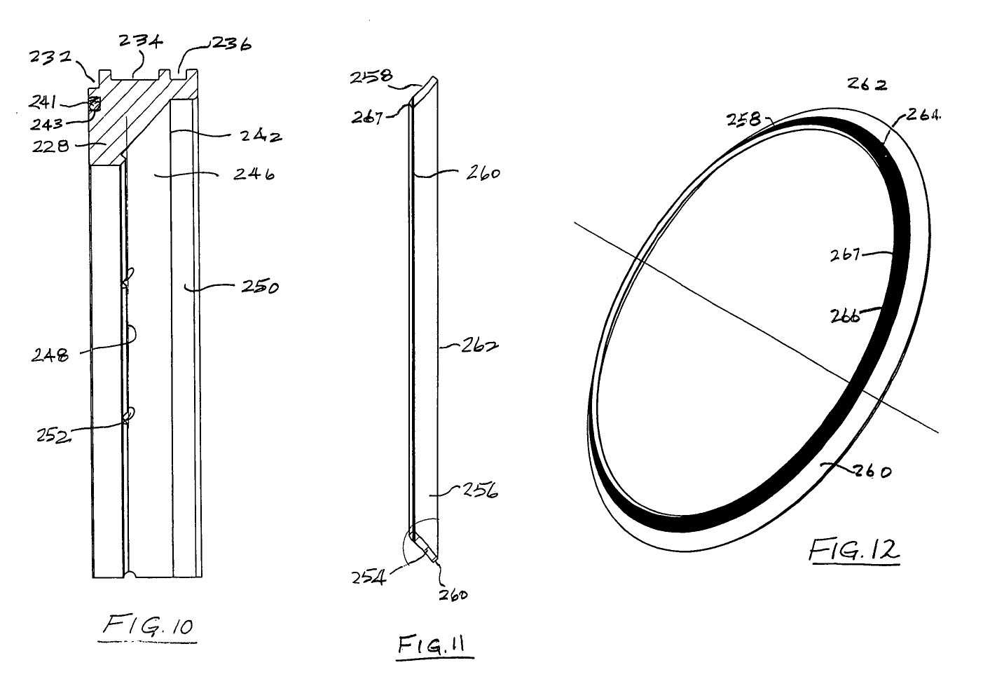

With reference now to FIGS. 9 and 10, a trunnion type ball valve embodying the principles of the present invention is shown generally at 190 and has an annular valve body 192 to which is secured a pair of tail-pieces 194 and 196 by means of a plurality of retainer members such as stud and bolt assemblies 198. The tail pieces are sealed to the annular valve body 192 by annular seals 195 and 197 that are preferably metal crush ring seals, but may take the form of resilient seals or polymer seals if desired. The tail pieces 194 and 196 may be designed for any suitable type of connection, such as weld end, flanged end, etc. for connection of the valve mechanism within a flow-line as mentioned above in connection with FIGS. 6 and 7. The valve actuating mechanism, being components of the top-works and shown generally at 200 in FIG. 9, is of the same general character as shown in FIGS. 3e and 6; thus like components are identified by like reference numerals.

The annular valve body and the connecting flanges of the tailpieces 194 and 196 cooperate to define an annular valve chamber 202 within which is position a rotatable ball member 204 having a spherical sealing surface 206. The tail pieces 194 and 196 define inlet and outlet flow passages 201 and 203 that intersect the valve chamber 202 and are aligned for registry with a flow port 205 of the rotatable ball member 204. The rotatable ball member 204 is mounted for rotation within the valve chamber 202 by upper and lower trunnion support members 208 and 210 that define respective aligned trunnion openings 212 and 214 within which upper and lower trunnion members 216 and 218 of the valve ball member 204 are received. Annular bearing members 220 and 222 are received within the respective upper and lower aligned trunnion openings 212 and 214 and receive and establish bearing support for the upper and lower trunnion members, thus mounting the valve ball member 204 for rotation about a pivot point or axis that is also substantially coincident with the longitudinal centerline C/L of the valve stem 36. The trunnion members 216 and 218 prevent upstream or downstream movement of the valve ball member 204, except for slight movement that may occur due to manufacturing tolerances. The trunnion members 216 and 218 each define seat carrier recesses 224 and 226 within which are disposed annular seat carrier members 228 and 230. The seat carrier members, as is also evident from FIG. 10, define at least one and preferably a plurality of annular seal grooves 232, 234 and 236 receiving annular seal members or seal assemblies and maintaining sealing with respect to annular seal carrier recess surfaces 238 and 240. When the seat carrier member is to be provided with a lubricating capability, the wide annular seal recess 234 will typically receive injected lubricant and transport it to a number of lubricant passages for distribution to the inner peripheral portion of the annular angulated seat recess.

Especially when the trunnion type ball valve design is employed in larger size valves the torque force that is required for rotation of the valve ball member between its open and closed positions may become quite high. In this event, as shown in FIGS. 10 and 10a, a self energizing back seal 241 is positioned within an annular seal groove 243. To minimize pressure responsive extrusion of the annular back seal ring 241, an annular seal support member 245 is movably positioned within the annular seal groove 243 and provides a tapered seal control surface 247. The seal support member 245 will be moved outwardly as shown in FIG. 10a for substantial contact with a tailpiece surface 249, thus supporting the annular back seal member 241.

The annular seat carrier members 228 and 230, as shown in FIG. 9 and best shown in FIG. 10 each define annular angulated seat recesses 242 and 244. Each annular angulated seat recess 242 defines an annular angulated seat recess surface 246 and radially inner and outer seat retainer shoulders 248 and 250. The seat carrier members may also define lubricant passages having openings 252 for distribution of injected lubricant essentially at the area of contact between the annular angulated seat members with the spherical sealing surface 206 of the valve ball member 204.

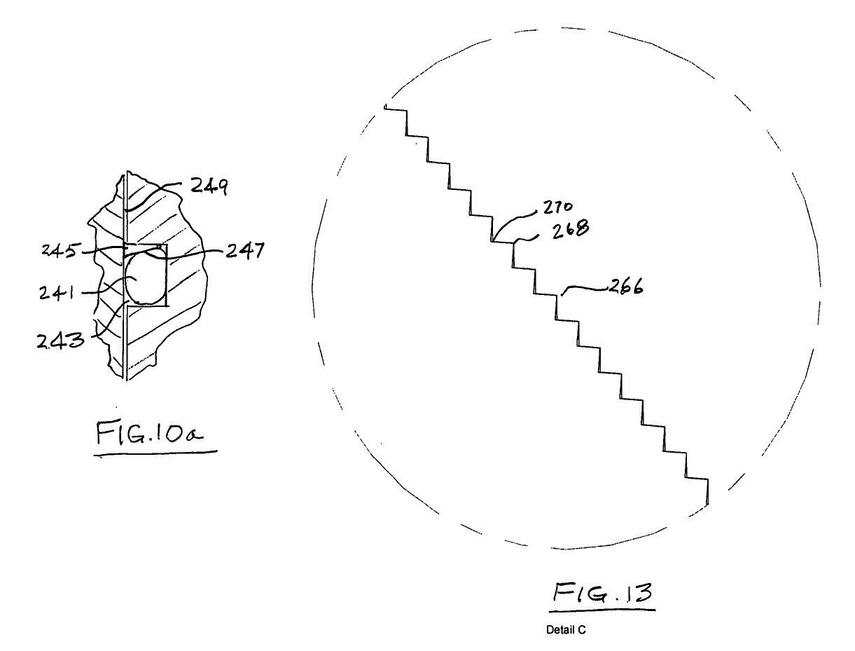

As shown in FIGS. 10-12, annular angulated spring-like seat members, one being shown at 254, is located within the respective seat recesses and is generally of the configuration and function as discussed above at 132 and 134 in FIG. 2. As shown in the sectional view of FIG. 11, the annular angulated spring-like seat member 254 defines an annular face sealing surface 256 for sealing engagement with the spherical sealing surface 206 of the valve ball member 204 and an annular back-face sealing surface 258 having sealing engagement with the angulated seat recess surface 246. It should be borne in mind that the annular spring-like seat members are each of generally frusto-conical configuration, however they are oppositely angulated since the seat recesses within which they are located each face toward the valve ball member. It should also be borne in mind that the face and back face sealing surfaces do not come into significant face to face sealing contact until such time as fluid pressure acting on the seal carriers becomes great enough to cause flexing or yielding of the seat members as discussed above in connection with FIGS. 3a-3d. Thus, the seat members function is similar manner whether they are present within a floating ball valve or a trunnion type ball valve. In the case of floating ball valves, pressure responsive valve ball movement causes flexing of the seat members to increase the area of sealing contact between the seat members and the valve ball. In the case of trunnion type ball valves the valve ball member is restrained by the trunnion members against pressure responsive movement and the seat carriers are moved toward the valve ball in response to increase in operating pressure, thus flexing or yielding the seat members and increasing the area of sealing contact.

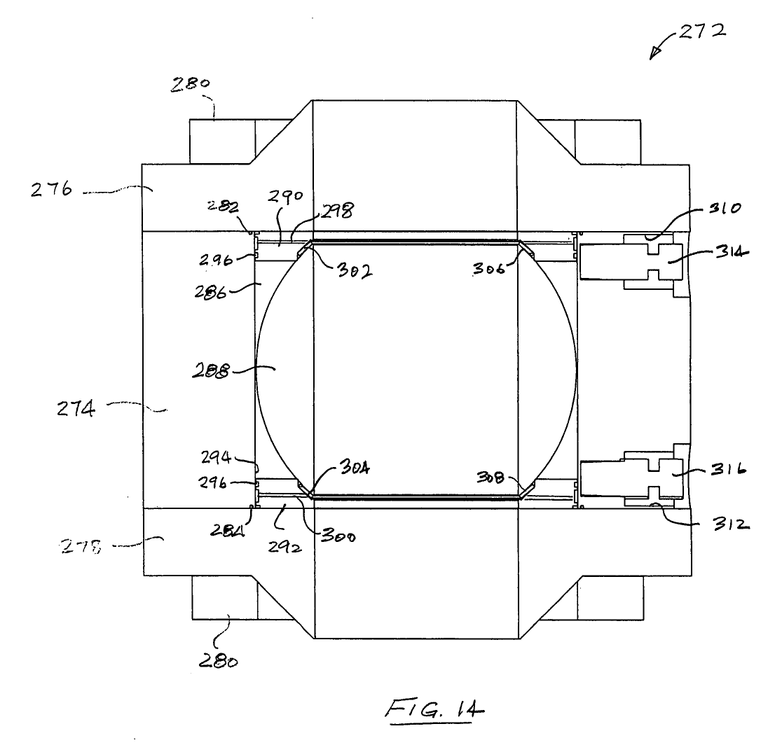

As shown in the isometric illustration of FIG. 12, the back-face surface 258 is constituted by a smooth or polished outer peripheral annular sealing surface 260 extending from the outer edge 262 to a suitable intermediate region 264. In contrast, an annular inner peripheral portion 266 of the back-face surface 258 is defined by a non-sealing surface region that extends to the inner peripheral edge 267 may have a roughened surface configuration as indicated in FIG. 13. The ridges 268 and grooves 270 will have a difference of dimension in the order of 0.0005 inches. However, it should be borne in mind that the non-sealing inner peripheral surface region 266 may be defined by knurling or by any other surface preparation that prevents sealing of the surface to the annular angulated seat recess surface 246. This feature permits the annular angulated seat members to have sufficient structural integrity for controlled flexing and yet minimizes the annular area of sealing contact between the seat members and the annular angulated seat recess surface.

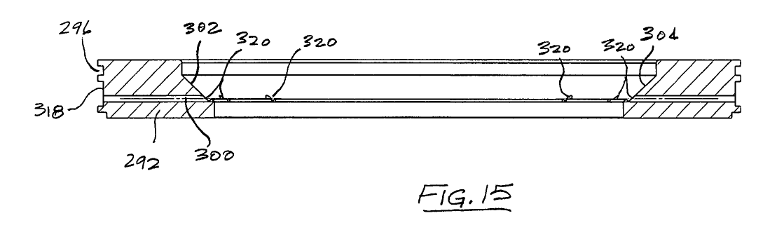

Referring now to FIGS. 14 and 15 a ball valve mechanism having lubricant enhanced sealing capability is shown generally at 272 and comprises an annular valve body member 274 having tail pieces 276 and 278 that are retained in assembly with the valve body by retainer members 280 such as stud and nut assemblies. The tail pieces are sealed to the valve body by annular sealing members 282 and 284 such as metal crush ring seals or any other suitable metal or non-metal seal members. The annular valve body member 274 and tail pieces cooperatively define a valve chamber 286 within which a valve ball member 288 is rotatable to open and closed positions during valve operation.

Annular seat carrier members 290 and 292, one being shown in detail in FIG. 15, are located within the valve chamber 286 and are sealed with respect to an inner surface 294 of the annular valve body member 274 by annular seal members 296 that are retained within annular seal grooves of the annular seat carrier members. The seat carrier members each define lubricant supply passages 298 and 300 that each have communication with respective annular angulated seat recesses 302 and 304. Annular angulated spring-like seat members 306 and 308 are retained within the respective angulated seat recesses 302 and 304. Lubricant injector receptacles 310 and 312 are defined in the annular valve body member 274 and retain lubricant injector members 314 and 316 that are actuated to inject lubricant into the annular lubricant grooves of the seat carrier members as shown at 318 of FIG. 15. Lubricant material injected into these external annular lubricant grooves will traverse the lubricant supply passages 298 and 300 and emerge at lubricant distribution openings 320 in the angulated seat recesses essentially at the inner peripheral seal contact regions of the seats and seat recesses, thus enhancing the sealing capability of the valve mechanism.

Assembly

In the case of the floating ball valve embodiment of the present invention, the valve stem 36 with the bearing and stem seal assembly 38 in assembly therewith is positioned within the stem passage of the valve body. The annular spring-like metal seat member 132 is then placed within the annular angulated seat recess 122 and the valve ball member 112 is positioned within the valve chamber of the valve body and in engagement with seat member 132 and with the stem slot or recess 118 thereof in non-rotatable relation with the valve stem. The downstream seat member 134 is then located within the angulated seat recess 120 of the tailpiece 18 and is centered with respect to the flow passage 30. Thereafter, the tailpiece 18 is assembled to the threaded studs projecting from the valve body. If the valve ball member 112 is at its open position the annular spring-like seat members will be centered with respect to the flow port 116 of the valve ball member as well as with respect to the flow passage 30 by the annular seat retainer rim 128 and by the annular retainer shoulder 130. The nuts of the stud and nut assemblies 22 are then rotated for tightening. During tightening of the stud and nut assemblies the assembly flange is drawn toward the valve body 12, causing the spherical sealing surface 114 of the valve ball member to come into contact with the radiused, smoothly contoured inner peripheral edge portions 138 of the annular spring-like seat members 132 and 134. Since the inner peripheries of the seat members are radiused as shown at 138 in FIGS. 3a-3c, no sharp edges of the seat members will be presented for contact with the spherical sealing surface. Also, the radiused inner peripheral edges 138 of the seat members may be of different diameters so that they may have different circular regions of engagement with the spherical sealing surface of the valve ball. At this point the outer peripheries of each of the metal seat members will typically be in slightly spaced relation with the radially outer extent of the angulated seat recess surfaces 126 as shown in FIG. 3a.

As the stud and nut assemblies are further tightened the radially outer extent of the angulated seat recess surface 126 will apply force to the radially outer portions of the flexible spring-like seat members 132 and 134. This force will be minimal and will be resisted by the spherical sealing surface of the valve ball, thus causing slight flexing of the seat members and establishing sufficient seat preload for initial sealing engagement of the inner peripheral radiused smoothly contoured edges of the seat members with the spherical sealing surface 114 of the valve ball member. Simultaneously sealing engagement of the outer peripheral radiused smoothly contoured edges 133 of the seat members with the angulated sealing surface 126 will be established as the force of assembly urges the seat members against the angulated sealing surfaces of the seat recesses. After the stud and nut assemblies have been tightened to their maximum extent the tailpiece 18 will be fully seated on the valve body 14 and the condition of FIG. 3b will have been established, with the seal members in sealing engagement with the valve ball and in sealing engagement with the angulated sealing surfaces.

During service conditions with the flow-line being under pressure and the valve mechanism closed, fluid pressure acting on the closed valve ball member will typically cause further yielding or flexing of the downstream seat member. At mid-range line pressure conditions the force of line pressure acting on the closed valve ball will shift the valve ball in the downstream direction, causing yielding of the downstream seat to fully seated and supported relation with the annular angulated seat recess surface 126. The spring-like characteristics of the seat members and the angular orientation of the angulated seat recess surfaces 126 will prevent the annular spring-like seat members from being yielded beyond the elastic limits thereof. Thus, on relaxing of a pressure induced force of the valve ball member, the spring characteristics of the annular seat members will return the seat members to the original slightly stressed configurations that were established during assembly of the valve mechanism.

For purposes of assembly of the trunnion ball valve, only the assembly of the valve mechanism of FIGS. 5-8 are discussed herein, assembly of the valve mechanisms of FIGS. 9 and 14 are much the same. Assembly of the trunnion ball valve of FIGS. 5-8 and is essentially the same as assembly of the floating ball valve mechanism, with the exception that the valve ball member 148, being designed for trunnion support within the valve body, is initially positioned within the annular valve body 142 with the trunnions 158 and 160 thereof being supported by the trunnion supports 162 and 164. The trunnions and trunnion supports restrict pressure responsive downstream movement of the valve ball member 148, however slight pressure responsive valve ball movement may occur due to manufacturing tolerances, and thus slight additional flexing of the annular spring-like seat members 132 and 134 will occur due to slight pressure responsive valve ball movement.

The seat carrier members, with the annular angulated seat members in the seat recesses thereof and seals within the respective seal grooves are placed within the annular valve body and the tail pieces are then assembled to the annular valve body and are tightened. During tightening of the tail pieces the tail pieces will apply force to the seat carriers thereby forcing the seat carriers toward one another, thus applying force to the annular angulated seat members. This will cause initial flexing of the annular angulated seat members, causing the radiused inner peripheral edges thereof to establish initial sealing with the spherical sealing surface of the valve ball and causing the radiused outer peripheral edges thereof to establish initial sealing with the angulated seat recess surfaces. When the floating or trunnion type ball valve mechanism is provided with a seat lubricating capability, often a quantity of lubricant is placed within the annular seat recesses as the annular seat members are placed therein. After assembly has been completed the lubricant injectors are then actuated to inject lubricant into the lubricant supply passages of the valve body and the seat carrier members.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

1. A ball valve, comprising:
a valve body defining a valve chamber and having inlet and outlet flow passages having juncture with said valve chamber, said valve body defining at least one angulated seat recess at said juncture, said angulated seat recess having an annular angulated seat recess surface;
a valve ball member having a generally spherical external sealing surface and having flow port therethrough and being mounted in said valve chamber for rotation between open and closed positions relative to said inlet and outlet flow passages and said seat recess; and
at least one annular spring-like seat member of generally rectangular cross-section positioned within said angulated seat recess and having a radiused and smoothly contoured inner periphery establishing a narrow band of sealing engagement with said generally spherical sealing surface and a radially outer periphery establishing annular sealing engagement with said annular angulated seat recess surface.

2. The ball valve of claim 1, comprising:
said annular spring-like seat member having an annular face surface and an annular back face surface.

3. The ball valve of claim 1, comprising:
said annular spring-like seat member having an annular face surface and an annular back face surface, a radially outer peripheral portion of said annular back face surface being surface hardened and polished for efficiency of sealing with said angulated seat recess surface and a radially inner peripheral portion of said annular back face surface being of non-sealing characteristic.

4. The ball valve of claim 1, comprising:
said annular angulated seat recess surface having a radially outer extent and a radially inner extent; and
said annular spring-like seat member having a circular outer peripheral edge being radiused and smoothly contoured and being in sealing engagement with said radially outer extent of said annular angulated seat recess surface.

5. The ball valve of claim 1, comprising:
said annular spring-like seat member having an annular face surface and an annular back face surface and having a radiused and smoothly contoured radially outer peripheral edge initially establishing a narrow annular band of sealing engagement with said annular angulated seat recess surface; and
said annular spring-like seat member being flexed and spring loaded by pressure responsive force of said valve ball member and causing at least a portion of said annular back face surface to establish sealing engagement with said annular angulated seat recess surface.

6. The ball valve of claim 1, comprising:
said annular angulated seat recess surface defining a radially inner extent and a radially outer extent; and
an annular seat retainer rim circumscribing said radially outer extent of said annular angulated seat recess surface and retaining said annular spring-like seat member within said annular angulated seat recess and maintaining substantial centering of said annular spring-like seat member with respect to said annular angulated seat recess surface.

7. The ball valve of claim 1, comprising:
said at least one annular spring-like seat member being a pair of annular spring-like seat members; and
said at least one angulated seat recess being a pair of annular angulated seat recesses each being located at said juncture of said inlet and outlet flow passages with said valve chamber and having annular an angulated seat recess receiving said annular spring-like seat members.

8. The ball valve of claim 1, comprising:
said at least one annular spring-like seat member being a pair of annular spring-like seat members;
said at least one angulated seat recess being a pair of angulated seat recesses each having an annular angulated sealing surface defining radially inner and outer extents; and
annular seat retainer rims circumscribing said radially outer extents of said annular angulated sealing surfaces and resisting lateral movement of said annular spring-like seat member during rotation of said valve ball member.

9. The ball valve of claim 1, comprising:
a stem passage being defined by said valve body;
a valve stem extending through said stem passage and having rotary driving engagement with said valve ball member;
a bearing and stem sealing assembly being located within said stem passage externally of said valve stem and maintaining sealing engagement between said valve body and said valve stem; and
a stem driver member being secured in non-rotatable driving engagement with said valve stem externally of said valve body

10. The ball valve of claim 9, comprising:
a cover member being fixed to said valve body and defining an opening within which said valve stem is located, said cover member defining an upper surface; and
a stem stop member projecting above said upper surface of said cover member and defining an axis of rotation and an exterior stop surface defining a stop for rotation stopping contact by said stem driver member and being eccentric with respect to said axis of rotation, said stem stop member being adjustably rotatably positioned with respect to said axis of rotation for adjusting the rotation stop position of said stem driver member.

11. The ball valve of claim 9, comprising:
spaced handle mounting stud members projecting from said stem driver member; and an elongate valve actuating handle member being mounted to said spaced handle mounting stud members and upon being moved causing rotational movement of said stem driver member and said valve stem and causing opening/closing rotation of said valve ball member.

12. The ball valve of claim 1, comprising:
a bearing and stem sealing assembly being located within said stem passage externally of said valve stem and sealing said valve stem with respect to valve body;
a follower member having force transmitting engagement with said bearing and stem sealing assembly and defining a packing actuator platform; and
a Belleville spring stack being positioned on said packing actuator platform and applying spring force to said packing actuator platform and to said bearing and stem sealing assembly.

13. The ball valve of claim 12, comprising:
a spring force adjusting screw engaging said Belleville spring stack and extending through said packing actuator platform and being threaded into said valve body, said spring force adjusting screw being selectively rotated and controlling application the spring force of said Belleville spring stack to said packing actuator platform and said bearing and stem sealing assembly.

14. The ball valve of claim 12, comprising:
a spring cover member being retained to said valve body and covering said follower member, Belleville spring stack and adjusting screw and preventing contamination thereof by environmental debris.

15. The ball valve of claim 14, comprising:
said spring cover member defining a plurality of opposed insert recesses and retainer openings intersecting said opposed insert recesses;
a rotation control insert being rotatably positioned within a first of said opposed insert recesses and a torque insert being located in non-rotatable relation within a second of said opposed insert recesses;
a retainer extending through said rotation control insert, said spring cover member and said torque insert and being threaded into said valve body; and
said rotation control insert projecting from said spring cover member and being positioned for rotation stopping engagement by said stem driver member.

16. The ball valve of claim 15, comprising:
said rotation control insert being a stem driver stop and having a retainer passage and an external stop adjustment surface being disposed in eccentric relation with said retainer passage; and
upon rotation of said rotation control insert said external annular surface moving eccentrically with respect to said retainer passage and adjusting the position of said external stop adjustment surface with respect to said spring cover and thus adjusting the stop position of said stem driver.

17. The ball valve of claim 1, comprising:
a bearing and stem sealing assembly being located within said stem passage externally of said valve stem and maintaining sealing engagement between said valve body and said valve stem;
a follower member having force transmitting engagement with said bearing and stem sealing assembly;
a Belleville spring stack being positioned on said follower member and applying spring force to said follower member and to said bearing and stem sealing assembly;
a spring cover member being retained to said valve body and covering said follower member and said Belleville spring stack and preventing contamination thereof by environmental debris; and
a rotation control stop member projecting from said spring cover member and being positioned for rotation limiting contact thereof by said stem driver member, said rotation control stop member being adjustable relative to said spring cover member for selective adjustment of the stop position of said stem driver.

18. The ball valve of claim 1, comprising:
a cover member being mounted to said valve body and receiving said valve stem therethrough and defining at least one insert receptacle having retainer opening therein;
a rotation stop insert being located within said insert receptacle and defining an external stop portion being eccentric with respect to said retainer opening; and
a retainer member securing said rotation stop in adjustable relation within said insert receptacle, upon loosening of said retainer member said rotation control member being rotatably adjustable within said insert receptacle for selective positioning of said external stop portion.

19. A ball valve, comprising:
a valve body defining a valve chamber and having inlet and outlet flow passages having juncture with said valve chamber, said valve body defining at least one annular seat recess at said juncture, said annular seat recess having an annular seat recess surface;
a valve ball member having a generally spherical external sealing surface and having flow port therethrough and being mounted in said valve chamber for rotation between open and closed positions relative to said inlet and outlet flow passages and said angulated seat recess;
an annular seat member being located within said annular seat recess and establishing sealing between said valve body and said valve ball member;
a valve stem extending in sealed and rotatable relation into said valve body and having non-rotatable driving engagement with said valve ball member;
a stem driver being disposed in driving relation with said valve stem and being rotated for imparting opening and closing rotation to said valve stem and said valve ball member;
a cover member being mounted to said valve body and receiving said valve stem therethrough and defining at least one insert receptacle having retainer opening therein;
a rotation stop insert being located within said insert receptacle and defining an external stop portion being eccentric with respect to said retainer opening; and
a retainer member securing said rotation stop in adjustable relation within said insert receptacle and securing said cover member to said valve body, upon loosening of said retainer member said rotation control member being rotatably adjustable within said insert receptacle for selective positioning of said external stop portion.

20. The ball valve of claim 19, comprising:
spaced handle mounting members projecting from said stem driver; and
an elongate valve actuating handle member being mounted to said spaced handle mounting members and upon being rotatably moved causing rotational movement of said stem driver member and said valve stem and causing opening/closing rotation of said valve ball member.

21. The ball valve of claim 19, comprising:
said at least one insert receptacle being a plurality of opposed insert receptacles and retainer openings intersecting said opposed insert receptacles;
a rotation control insert being positioned within a first of said opposed insert receptacles and a torque insert being within a second of said opposed insert receptacles, said rotation control insert having a retainer opening and defining an adjustment portion being eccentric with respect to said retainer opening;
retainer means securing said spring cover member to said valve body and securing said rotation control insert and said torque insert in assembly with said spring cover member; and
said rotation control insert projecting from said spring cover member and being selectively positioned and defining a selectively adjustable rotational stop position for said stem driver member.

22. The ball valve of claim 21, comprising:
said rotation control insert being a stem driver stop and having a retainer passage and an external adjustment surface being disposed in eccentric relation with said retainer passage; and
upon rotation of said rotation control insert said external adjustment surface moving eccentrically with respect to said retainer passage and adjusting the position of said external adjustment surface with respect to said spring cover and thus adjusting the stop position of said stem driver.

23. A ball valve, comprising:
a valve body defining a valve chamber and having inlet and outlet flow passages having juncture with said valve chamber, said valve body defining angulated seat recesses at said juncture, said angulated seat recesses each having an annular angulated seat recess surface;
a valve ball member having a generally spherical external sealing surface and having flow port therethrough and being mounted in said valve chamber for rotation between open and closed positions relative to said inlet and outlet flow passages and said seat recess;
a pair of annular spring-like seat members of generally rectangular cross-section each being positioned within one of said angulated seat recesses and having an annular face sealing surface and an annular back face sealing surface, said annular spring-like seat members initially establishing annular regions of sealing engagement of said annular face sealing surfaces thereof with said spherical sealing surface of said valve ball member and establishing an annular region of sealing engagement of said annular back face sealing surfaces thereof with said annular angulated seat recess surfaces, said annular spring-like seat members having inner and outer circular edges each having juncture with said face sealing surface and said back face sealing surface;
said inner circular edges of said annular spring-like seat members being radiused at said juncture with said annular face sealing surface and providing a smoothly contoured inner circular edge minimizing seat contact erosion of said spherical sealing surface of said valve ball member; and
said radially outer circular edges of said annular spring-like seat members being radiused at said juncture with said annular back face sealing surface and providing a smoothly contoured radially outer circular edge being in sealing engagement with said angulated seat recess surface.

24. The ball valve of claim 23, comprising:
said annular face surface and said annular back face surface each being surface hardened and said annular face surface being polished for efficient sealing engagement with said valve ball.

25. The ball valve of claim 23, comprising:
a radially outer portion of said annular back face surface being surface hardened and polished for efficiency of sealing with said annular angulated seat recess surface and a radially inner portion of said annular back face surface having non-sealing characteristic.

26. The ball valve of claim 23, comprising:
said annular face surface and said annular back face surface each being surface hardened;
at least a radially inner portion of said annular face surface being polished for efficiency of sealing and resistance to erosion; and
a radially outer portion of said annular back face surface being polished for efficiency of sealing with said annular angulated seat recess surface and a radially inner portion of said annular back face surface being of non-sealing characteristic to prevent sealing thereof with said annular seat recess surface.

27. The ball valve of claim 23, comprising:
a stem passage being defined by said valve body;
a valve stem extending through said stem passage and having driving engagement with said valve ball member;
a bearing and stem sealing assembly being located within said stem passage externally of said valve stem and maintaining sealing engagement between said valve body and said valve stem;
a stem driver member being secured in non-rotatable driving engagement with said valve stem externally of said valve body and having spaced handle mounting stud members projecting therefrom; and
an elongate valve actuating handle member being mounted to said spaced handle mounting stud members and upon being moved causing rotational movement of said stem drive member and said valve stem and opening/closing rotation of said valve ball member.

28. The ball valve of claim 23, comprising:
a bearing and stem sealing assembly being located within said stem passage externally of said valve stem and maintaining sealing engagement between said valve body and said valve stem;
a follower member having force transmitting engagement with said bearing and stem sealing assembly and defining a packing actuator platform;
a Belleville spring stack being positioned on said packing actuator platform and applying spring force to said packing actuator platform and to said bearing and stem sealing assembly; and
a spring force adjusting screw engaging said Belleville spring stack and extending through said packing actuator platform and being threaded into said valve body, said adjusting screw being selectively rotated and controlling application the spring force of said Belleville spring stack to said packing actuator platform and said bearing and stem sealing assembly.

29. The ball valve of claim 23, comprising:
a spring cover member being retained to said valve body;
a stem driver being mounted to said valve stem and being rotated to impart valve operating rotation to said valve stem and said valve ball member; and
an adjustable rotation control member projecting from said spring cover and defining an adjustable rotation stop for said stem driver and having an axis of rotation and an external annular stop adjustment surface being eccentric with respect to said axis of rotation, upon rotation of said adjustable rotation control member said external adjustment surface moving eccentrically with respect to said axis of rotation and adjusting the position of said external annular stop adjustment surface with respect to said spring cover and thus adjusting the stop position of said stem driver.

30. The ball valve of claim 23, comprising:
a spring cover member being retained to said valve body and covering said follower member and said Belleville spring stack and preventing contamination thereof by environmental debris;
said spring cover member defining a plurality of opposed insert recesses and cap screw openings intersecting said opposed insert recesses;
a rotation control insert being positioned within a first of said opposed insert recesses and projecting above said spring housing and serving as a rotation stop for engagement by said stem driver, said rotation control insert being adjustable relative to said spring cover and thus adjusting the stop position of said stem driver;
a torque insert being located in non-rotatable relation within a second of said opposed insert recesses;
a cap screw extending through said rotation control insert, through said spring cover member and being threaded into said torque insert.

31. The ball valve of claim 30, comprising:
said rotation control insert having a cap screw passage and an external stop adjustment surface being disposed in eccentric relation with said cap screw passage; and
upon rotation of said rotation control insert relative to said cap screw said external stop adjustment surface moving eccentrically with respect to said cap screw and adjusting the position of said rotation control insert with respect to said spring cover and thus adjusting the stop position of said stem driver.

32. The ball valve of claim 23, comprising:
a bearing and stem sealing assembly being located within said stem passage externally of said valve stem and maintaining sealing engagement between said valve body and said valve stem;
a follower member having force transmitting engagement with said bearing and stem sealing assembly;
a Belleville spring stack engaging said follower member and applying spring force to said follower member and to said bearing and stem sealing assembly;
a spring cover member being retained to said valve body and covering said follower member and said Belleville spring stack and preventing contamination thereof by environmental debris; and
a rotation stop projecting from said spring cover member and being postioned for rotation limiting contact thereof by said stem driver member, said rotation stop being adjustable relative to said spring cover and thus adjusting the stop position of said stem driver.

33. The ball valve of claim 23, comprising:
a protective cover being mounted to said valve body and defining a plurality of opposed insert recesses and cap screw openings intersecting said opposed insert recesses;
a rotation control insert being positioned within a first of said opposed insert recesses and projecting above said protective cover and serving as a rotation stop for engagement by said stem driver, said rotation control insert being adjustable relative to said spring cover and thus adjusting the stop position of said stem driver;
a torque insert being located in non-rotatable relation within a second of said opposed insert recesses; and
a cap screw extending through said rotation control insert, through said spring cover member and being threaded into said torque insert.

34. The ball valve of claim 33, comprising:
said rotation control insert having a cap screw passage and an external stop adjustment surface being disposed in eccentric relation with said cap screw passage; and
upon rotation of said rotation control insert relative to said cap screw said external stop adjustment surface moving eccentrically with respect to said cap screw and adjusting the stop position of said rotation control insert with respect to said spring cover and thus adjusting the stop position of said stem driver.

35. A ball valve, comprising:
a valve body defining a valve chamber and having inlet and outlet flow passages having juncture with said valve chamber;
angulated seat recesses being located within said valve chamber and defining annular angulated seat recess surfaces;
a valve ball member having a generally spherical external sealing surface and having flow port therethrough and being mounted in said valve chamber for rotation between open and closed positions relative to said inlet and outlet flow passages and said seat recesses; and
annular seat members of generally rectangular cross-section positioned within said angulated seat recess and each having a radiused and smoothly contoured inner periphery establishing a narrow band of sealing engagement with said generally spherical sealing surface and defining a radially outer periphery establishing annular sealing engagement with said annular angulated seat recess surface.

36. The ball valve of claim 35, comprising:
said valve ball member defining opposed trunnion members;
trunnion support members being disposed within said valve body and supporting said valve ball member for rotation; and
seat carrier members being located within said valve chamber and defining said angulated seat recesses.

37. The ball valve of claim 36, comprising:
said seat carrier members each having annular back surfaces;
annular back seal grooves being defined in said seat carrier members; and
annular back seal members being disposed within said annular back seal grooves and minimizing pressure energization of said seat carrier members and thus limiting the torque force that is required for rotation of said valve ball member.

38. The ball valve of claim 36, comprising:
lubricant passage means being located within said valve body and said seat carrier members and having lubricant distribution openings within said angulated seat recesses

39. The ball valve of claim 35, comprising:
lubricant passage means being located within said valve body and having lubricant distribution openings within said angulated seat recesses; and
lubricant injector means being mounted to said valve body and supplying lubricant to said lubricant passage means.
